(19) United States
(12) Patent Application Publication
(10) Pub. No.: US 2012/0138539 A1
(43) Pub. Date: Jun. 7, 2012

(54) Method and Apparatus For Extraction of Hydrocarbons From a Body of Water Using Recovery Particle Binding

(76) Inventor: John Cogliandro, Dedham, MA (US)

(21) Appl. No.: 12/959,591

(22) Filed: Dec. 3, 2010

(51) Int. Cl. C02F 1/48; C02F 1/40; C02F 1/52

(52) U.S. Cl. 210/695; 210/702

(57) ABSTRACT

The extraction of hydrocarbons or other contaminates from a body of water or fluids is accomplished by distributing recovery particles with an affinity for hydrocarbons (or an affinity specifically designed for the contaminate of concern) into the contaminated body of fluids, allowing for adherence between the particle and the contaminate, and subsequent removal of the contaminate/recovery particle matrix by use of a magnet or other mechanical or electromechanical or electrochemical means to subsequently attract the contaminate/recovery particle matrix to a fixed point, removing them from the body of fluids (obtaining high volumetric removal efficiency) and providing equipment to separate the contaminate/recovery particle matrix from the equipment preparing the equipment for reuse and subsequently separating the contaminate from the recovery particle for reuse of the particle if desired and eventual disposition of the contaminate.

### BACKGROUND OF THE INVENTION

1. Field of the Invention

This invention relates generally to extraction of hydrocarbons or other contaminates from a body of water or fluids from the surface and subsurface of formations such as oceans, lakes, ponds, rivers, estuaries, industrial tanks, settling ponds, and reservoirs, and in particular to a method and apparatus for extraction of oil and hydrocarbons from oceans and other body's of water in situ utilizing magnetic capable particles, distribution equipment or methods, and particle recovery magnets and exsitu washing equipment and methods.

2. Description of Related Art

Oceans, lakes, ponds, rivers, estuaries, industrial tanks, settling ponds, and reservoirs are often contaminated by hydrocarbons or other pollutants (weather a pollutant or useful substance is immaterial here, as the basis is that this is a foreign substance in need of removal for later processing, either for profit or for disposal). There are also situations where industrial tanks and settling ponds are purposely infiltrated with hydrocarbons or other substances for later removal. There are many methods for removal of these contaminates or materials, usually suboptimal and incomplete. The methods include skimming using mechanical means, skimming using absorbents, absorbent and manual or mechanical recovery, vacuums attached to settling tanks, pumping of commingled fluids through a centrifuge to separate components, burning, solvent based extraction and separation, algae digestion, dispersants, surfactants, soaps, heating, cooling and so on. These methods have developed over the centuries, with a significant amount of the technology development linked to oil spills from drilling rigs in the ocean. These developments are often linear, they are incremental improvements to known science driven by the high financial penalties levied on firms that contaminate bodies of drinking or sea water or land. A typical example is the containment and response needed for just a gallon of diesel fuel spilled during a trucking accident on a highway. Typically an oil absorbent boom or porous membrane is placed around the perimeter, other absorbents are placed directly on the spill, HAZMAT remediation teams are called for further labor intensive, manual cleaning, and so on. Many states require immediate response using absorbents, removal of all contaminated soils within a large perimeter, remediation of any body of water near by if contaminates reaches it, and so on, with costs reaching in the tens of thousands of dollars for a very small spill. Likewise, larger spills, especially in water require much remediation expense and labor. Each of these methods have limitations, ranging from low separation efficiency to high manual labor content to difficulty and expense of scaling up from laboratory or small industrial scale to large ocean scale.

For the recent large ocean based oil spills, from Exxon Valdese to Deepwater Horizons, the spill response and containment activities and technologies are similar to those of a simple gallon of diesel or other contaminates, on a much larger scale. The methods include surface skimming, chemical dispersants, and the like. These large ocean spills have unique difficulties due to the tremendous volume of fluids (both water and oil) as well as the vast distances of the ocean, temperature deltas, waves, weather and other factors. These factors all have substantial impact on recovery cost, time and the methods used, often all of which are suboptimal or non productive at all. It is estimated that all of the many methods and extraordinary expense of the recent Deepwater Horizons Louisiana USA Spill recovery efforts, in total, have only recovered approximately 30-40% of the spilled oil.

Further, the ocean or other large body of water often has temperature gradients, often called “thermals” which act like horizontal highways for floating debris at levels below the surface. Often portions of high viscosity non-transformed material, eg. Heavy oils are suspended in these thermals such that never reach the surface and they cannot be accessed within the water or fluids/oil/contaminate matrix. Regardless of thermals, often these “heavier” oils are trapped in bubbles below the surface of the ocean, lacking the density difference or buoyancy needed to rise to the surface. It is estimated that over half of the oil spilled from the Deepwater Horizon spill is still beneath the surface, immune to skimming and dispersants and special methods are needed to recover this pollutant.

Recovered contaminates are disposed of in various ways, often simple burning is effected due to cost constraints. Sometimes the oil is recovered and refined into usable marketable products. Most pollutants along with large amounts of native material (water, sand, dirt) are eventually burned in a cement kiln to destroy the pollutant and the residue is then disposed of in an approved land fill. The addition of the native material is a huge cost driver, multiplying the total volume and weight of material to be disposed of by many tens of orders of magnitude. Again, a slow, expensive and suboptimal method compared to on-the-spot recovery of primarily the contaminate and reuse.

### SUMMARY OF THE INVENTION

Accordingly, it is therefore an object of this invention to provide a method and apparatus for extraction of hydrocarbons or other contaminates from a body of water or fluids using disbursed recovery particles capable of magnetic attraction with an affinity for hydrocarbons (or an affinity specifically designed for the contaminate of concern) and a magnet to attract the oil/contaminate/particle matrix and equipment to clean the magnets and or recovery particles, return them to service and separate the contaminate for further processing.

It is another object of this invention to provide a method and apparatus for in situ extraction of contaminates from an industrial tank using recovery particles specifically designed to remove the contaminate or particulate of interest—in the case of recycling or reclaiming of a certain material such as chromium from a larger body of scrap metal and plastic—from the tank.

It is a further object of this invention to provide a method and apparatus for effectively reusing and/or recycling the recovery particles and the magnets used in the reclamation process

It is a further object of this invention to provide a method and apparatus for effectively separating the contaminate from the base or native body of fluids without removing large amounts of the native fluid for disposal

It is a further object of this invention to provide a method and apparatus for effectively recycling the recovered oil or contaminate with or without the recovery particle intact

It is a further object of this invention to provide a method and apparatus for effectively disbursing or distributing the recovery particles over small or large areas, either above or below the surface of the body of water or fluids, such as using an airplane equipped with tanks and distribution equipment such as nozzles, such as a common crop dusting airplane

It is a further object of this invention to provide a method and apparatus for injection of recovery particles into a semi-aqueous or non-aqueous land based site, such as sand, quick sand, sand stone, dirt or other semi-solid matrix using nozzles and if needed a delivery fluid such as Carbon Dioxide, water or propane.

It is a further object of this invention to provide a method and apparatus for large scale recovery of the recovery particle/oil/contaminate matrix in any sea state such as using a large scale towed electro magnet or rare earth magnet behind an industrial trawler type boat.

It is a further object of this invention to provide a method and apparatus for large scale excitation of the recovery particle absorbance or adherence to the contaminate by way of adding an electrical field between plates prior to full magnetization for recovery of the recovery particle/oil/contaminate matrix.

It is another object of this invention to provide a method and apparatus for continuous recovery of the recovery particle/oil/contaminate matrix in any sea state such as using a large scale conveyor based electro magnet or rare earth magnet rotating through the fluid-particle-contaminate matrix in a cleaning station. The cleaning station may by example be within or behind an industrial trawler type boat, perhaps combined with a vacuum system and/or within or behind a tractor trailer or other apparatus designed for the situation at hand.

It is a further object of this invention to provide a method and apparatus for remediation of oil and other hydrocarbons or other contaminates from a spill site, land fill or other environmentally sensitive situation by using a combination of disbursed recovery particles with an affinity for hydrocarbons (or affinity for for the contaminate of concern) and a magnet to attract the oil/particle matrix and equipment to clean the magnets and return them to service and to recover liquid and gas or other contaminates from same.

It is yet another object of this invention to provide a method and apparatus to remove material from any container with-out danger to humans, such as divers or cleaners who enter the tank, such as when humans attempt to clean a large industrial tank of chemicals or oil sludge.

Additional objects, features and advantages of the invention will become apparent to those skilled in the art upon consideration of the following detailed description of the preferred embodiments exemplifying the best mode of carrying out the invention as presently perceived.

### BRIEF DESCRIPTION OF THE DRAWINGS

The appended claims particularly point out and distinctly claim the subject matter of this invention. The various objects, advantages and novel features of this invention will be more fully apparent from a reading of the following detailed description in conjunction with the accompanying drawings in which like reference numerals refer to like parts, and in which:

FIG. 1 is an overall view of the process and equipment of a method of removing hydrocarbons or other contaminates from a body of water or fluids according to the present invention.

FIG. 2 is a flow chart of the preparation phase

FIG. 3 in combination illustrates the system of the present invention including seeding phase

FIG. 4 in combination illustrates the system of the present invention including recovery phase

FIG. 5 in combination illustrates the system of the present invention including reclamation and disposal phase

### DESCRIPTION OF THE PREFERRED EMBODIMENTS

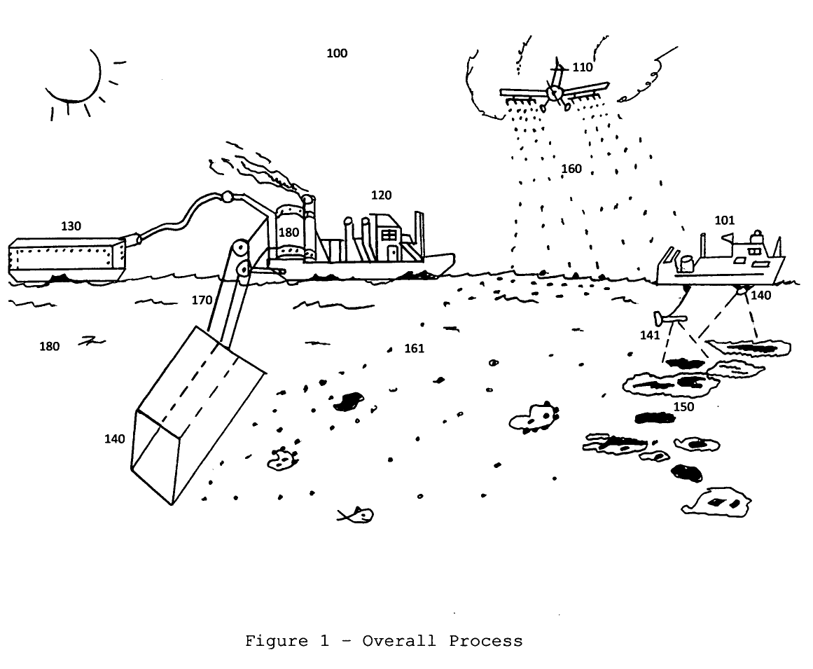

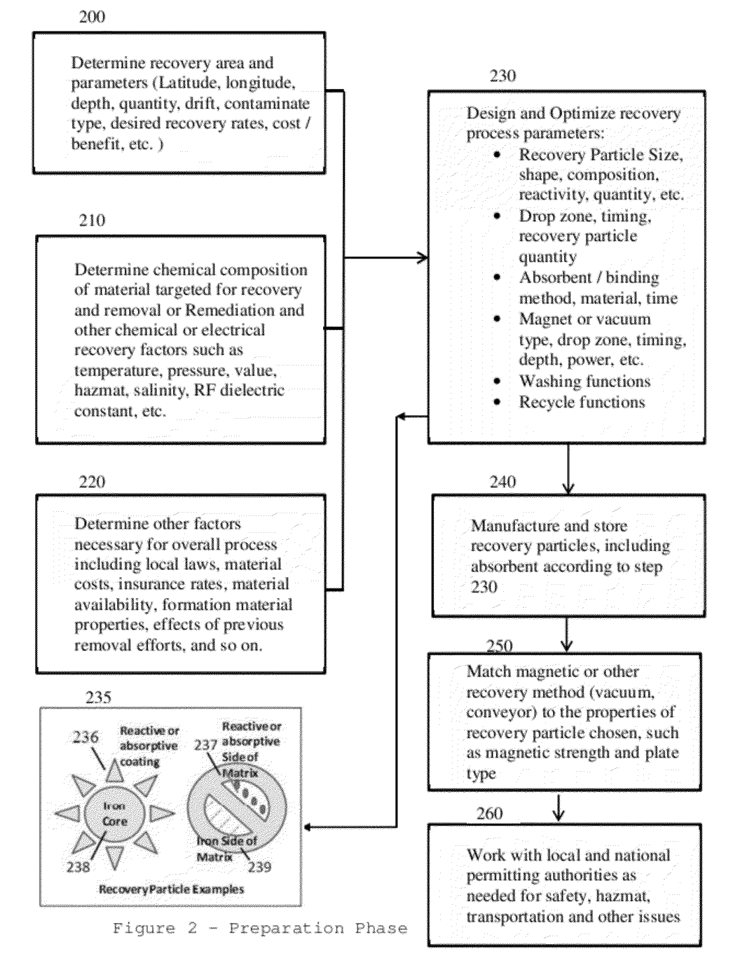

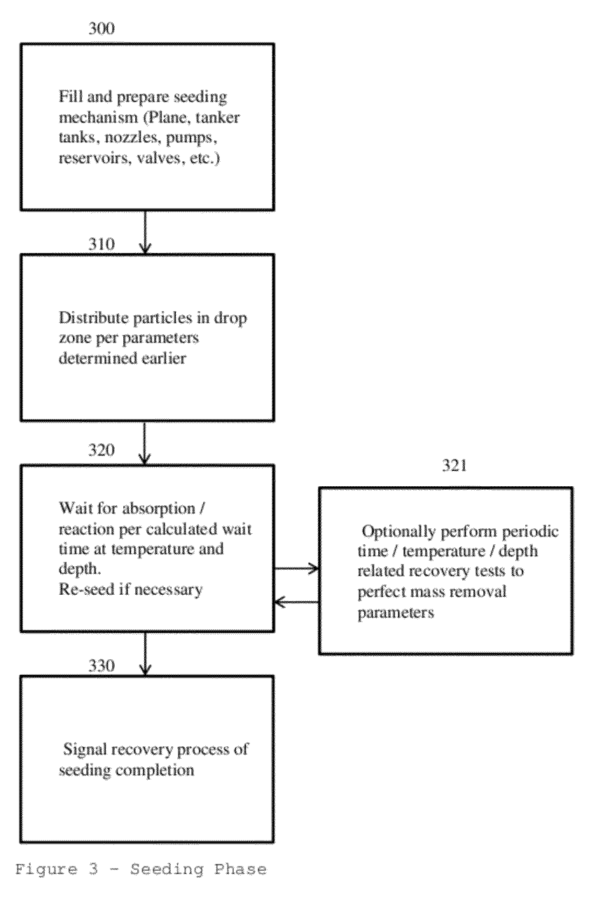

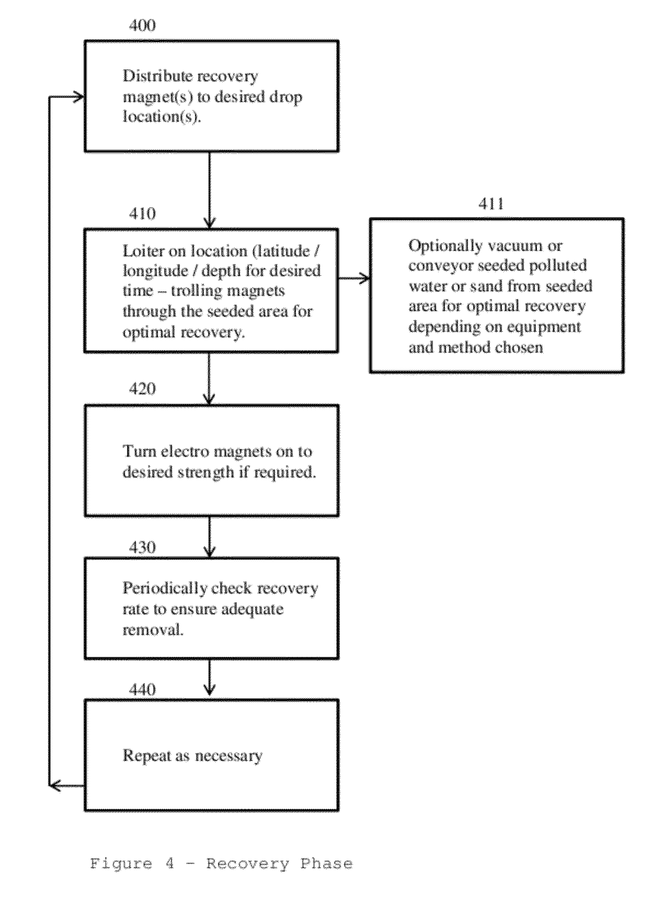

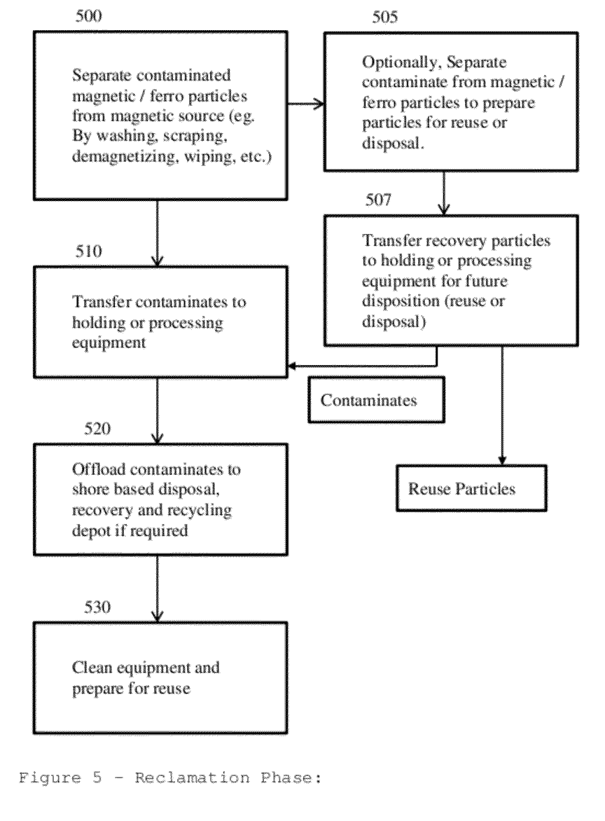

Referring to FIG. 1, FIG. 2, FIG. 3, FIG. 4, and FIG. 5, the figures show the steps of a method (100) of removing hydrocarbons or other contaminates (150) from a body of water or fluids, such as an ocean (180), or heavy oil within a sand matrix, or heavy petroleum from a spent well, or hydrocarbons or other contaminates or valued commodities from an industrial tank. FIGS. 1, 2, 3, 4, and 5 individually and together illustrate a system for accomplishing the method.

Referring to FIGS. 1,2,3,4, and 5 the method and apparatus comprises the removal of oil or contaminates by the steps of preparing for the distribution of recovery particles (160) with an affinity for hydrocarbons (or an affinity specifically designed for the contaminate of concern) (235) into a body of water or fluid or industrial tank or material mass to a first predetermined density (161) based on the estimates of the location and amount of contaminate to remove such as from a sonar equipped ship with discrimination algorithms, GPS or other coordinate equipment, temperature, current, wind and other environmental sensors able to determine volume, density and location of the contaminates (140, 200, 300, 310), and the amount of contaminate expected to adhere to the particle (b) the method comprises the steps of seeding (distributing) the recovery particles (110, 300, 310)) and for a “soak” time, a time necessary for the attraction between the oil or contaminate to adhere to the recovery particle (320), weather the attraction is a chemical bond, physical bond, electrical bond or other adherence (236, 237), and for, if needed, the particle to reach a certain depth including the depth of 0, eg. surface (c) the method and apparatus of the recovery phase the steps of providing a signal to begin recovery (330) with a magnet to attract the oil/recovery particle matrix (140) by the means of placing the magnet in magnetic field proximity to the contaminate/recovery particle matrix such as by towing through, towing above or below (140, 170) with a work ship (120), vacuuming into a magnetic lined container, pouring over magnetic lined conveyors and so on, (d) the method and apparatus and equipment of the recovery phase including the steps to recover the magnet if detached from the primary operational facility (170), and (e) the method and apparatus of the reclamation phase including the steps to clean the magnets (separate the oil/recovery particle matrix from the surface of the magnet) (500, 180, 130) and return them to service (f) the method and apparatus of the reclamation phase including the steps of providing equipment and means for separating the oil or contaminate from the recovery particle if desired either reuse the particles (505), make the oil or contaminate reclamation more cost effective or both (g) the method and apparatus of the disposal phase including the steps of providing equipment or means for the removal of the oil or contaminate from the process and process equipment for later reuse (520, 507), recycle or disposal such as a settling tank with pipes and pumps (180, 130, 510).

Still referring to the method described in FIG. 1 and FIG. 2 during the preparation phase including the steps which are further accomplished by a method of producing iron based particles (200-240)—eg. aforementioned “recovery particles” which are often composites of iron plus other materials—that have a chemical, physical and or electrical binding property with the hydrocarbon or contaminate as well as the capacity to be magnetized or be attracted to a magnet.

Still referring to the preparation phase of FIG. 2 and the seeding and distribution phase of FIG. 3 a particle is needed to be specified (230). Typically a particle such as a Faujasite (FAU) and zeoliteA (LTA) or other porous zeolites (aluminosilicates) with a ferrous backbone (ferrosilicates) or a ferrous based aerogel particle or Magnetic Iron Oxide Nanocrystals in the 10 to 30 nm range (or other near nano sized particle) (235-240) is produced and customized for the application at hand. The particles do not need to be in the nano size range, and can be much larger if the situation dictates the larger particle. In some instances, such as heavy seas with deeply submerged heavy oil globules, iron particles (238) in the marble sized range are required (0.1 to 0.5 inch diameter) to effect sinking to the required depth on location, in a timely fashion. The typical case using porous particles involves customization and expansion of the pore structure (the amorphous regions) (236, 237) to attract and accommodate the hydrocarbon—either mechanically or through chemical or electrical reaction selectively if needed. Metal-organic frameworks and zeolitic imidazolate frameworks (ZIFs) and ferrite based aerogels are capable of absorbing large amounts of hydrocarbons, either gaseous or liquid, (by weight and volume) and then being recovered using a rare earth magnet, permanent magnet or electro magnet (140, 410-430)). In the case where a non-porous iron ball is used, the secondary absorptive material (236) is bonded to the iron particle (238) providing a absorptive/recovery system (235).

Creating the correct recovery particle requires that the magnet—particle material be matched (140, 250). Various particle materials can react differently to the presence of an external magnetic field. This reaction is dependent on a number of factors, such as the atomic and molecular structure of the material and the atoms properties. Paramagnetic and preferably Ferromagnetic materials are suitable due to their attraction to an external magnetic field. Magnetic Force Microscopy (MFM) can be used to ascertain the suitability of a particle, as can a simple magnetograph. It is important that the particle exhibit low retentivity so that the particles themselves never become strongly magnetized so they do not attract to each other in clumps and reduce the total surface area exposed to the oil/contaminate. However, it can be envisioned that certain circumstances exist that a mild retentivity may be advantageous. Furthermore, in preparation for the seeding distribution phase of FIG. 3 and recovery phase of FIG. 4, the equipment must be appropriately designed and sized to match the particle size and properties (250, 410, 411).

Referring to FIGS. 1 and 2, likewise, a simple coated iron particle may be developed (235) (iron balls, magnetite (Fe₃O₄), maghemite (gamma Fe₂O₃), magnetic ferrites, such as cobalt ferrite or manganese ferrite, iron oxide and various derivatives) whereby the coating is oil-filic (attracts oil or attracts the desired contaminate). This system may be less cost than the ZIF or Aerogel compound, relying on a lower cost method of coating iron or iron oxide balls with absorbents, polymers and attractants customized to the pollutant targeted for removal. The rest of the recovery process would be similar.

Additionally, referring to FIG. 4, the process was exercised in laboratory testing by the inventor who used the low cost method with much success, such that iron oxide balls were coated with a cellulose fiber and exposed to used motor oil in a salt water pond. The cellulose iron particles were allowed to mingle with the oil-water matrix for approximately 1 hour (400-411). The oil adhered to the particles and was removed from various depths using a permanent magnet towed through the pond set at depths for each tow as seen in FIGS. 1 and 4. Speed of the tow was adjusted for depth and temperature, whereby the lower depths which typically have colder water require a slightly slower tow speed, about 0.6 MPH (six tenths of one mile per hour) to maintain optimal recovery, the method was checked (430-440) and additionally, since cellulose coated iron particles tend to sink until they come in contact with oil, the lower depths were recovered first prior to the higher depths where the lighter hydrocarbons tend to maintain their position on or near the surface and so speed at the higher depths including the surface was successfully varied from 0.8 MPH to 1.4 MPH, additionally experiments were also conducted whereby the cellulose iron particles were bonded to a particle of Styrofoam for buoyancy. As seen in FIG. 1, a support ship (101) using towed sonar arrays (141), or fixed sonar arrays (140) can locate the contaminate within the water volume, while it also samples temperature, current depth and viscosity of the water and contaminate. This information is used to tune the overall process (230-260), as well as to locate the main recovery ship (120), the recovery magnets (140) and control the speed and depth of the recovery ship and magnets (120, 170, 140 where the depth and power lines (170) can be continuously adjusted. In an alternate embodiment, the recovery particle (160) depth and density (161) could be varied by adjusting the cellulose/Styrofoam/iron ratio for an almost infinitely variable recovery depth which is useful for heavy oils which tend to sit at various depths below the surface.

Furthermore, the method and apparatus described in FIGS. 1, 2, 3, 4 and 5 were reduced to practice which included the steps required for removal and recovery of the heavy oil globules where the depth of the contaminate is known through some means, such as sonar mapping (140), then the iron/flotation foam/recovery particle can be designed to sink to a specific depth for optimal recovery. In an alternate embodiment the method and apparatus for raising the particles from depths for a surface recovery was proven using experiments in which air bubbles were disbursed below the cellulose iron recovery particles after they were allowed to sink through the oil strata and absorb oil and the bubbles were released from a depth below the recovery zone and adhered to the cellulose fibers raising the oil-recovery particle up, sometimes to the surface, sometimes to a level below the surface where by traditional skimming methods and/or the magnetic recovery method were subsequently used successfully. In an alternate embodiment the entire process can be performed in a sand matrix (such as the edge of the ocean, a beach) where the plane may be replaced by other seeding mechanisms and the towed magnet may be replaced by scooping conveyors, etc.

The method of FIG. 4 comprises a steps using magnetic recovery of the collection particles in which the strength of the magnet in FIG. 4 (400-420), preferably an electro magnet that can be turned on and off during various stages of the attracting and cleaning process, can be determined and controlled. The units for magnetic field strength H are ampere/meter, however most are purchased based on holding force. A powerful magnet may have a holding force of 10,000 lbs, or even up to 50,000 tons. Permanent Magnets and magnetic assemblies typically contain Samarium Cobalt magnets, Neodymium Iron Boron magnets (Rare Earth), Aluminum Nickel Cobalt magnets (Alnico) and Ceramic (Ferrites). These are useful for the conveyor approach, while an electro magnet may be preferred for the towed open ocean approach, however both are interchangeable with the correct design.

Additionally, referring again to FIGS. 3, 4 and 5 the steps for separating the contaminate/recovery particle matrix from the base solution (eg. Ocean, river, lake, sand, etc.) through magnetization resulting in attachment to the walls of the magnet, and the steps of washing and separation of the contaminate/recovery particle (500, 505) can begin as in FIG. 5, whereby the term “washing” is generic for separation of particles from the magnet. Depending on the contaminate and the particle, the washing can be as simple as discarding the entire matrix (530) and burning it in a cement kiln or as elaborate as using supercritical C02 to literally wash the contaminate or hydrocarbon from the particle, and reusing the particle (505, 507). Often, if the C02 washing method is used, or similar, the contaminate is then separated from the C02 after allowing the C02 to come out of solution and reusing the Co2 as seen in the high and low pressure tank, 180 located on the main recovery ship. Larger particles are easier to clean than smaller particles. Smaller particles may take longer times and or multiple washes.

This invention has been disclosed in terms of certain embodiment. It will be apparent that many modifications can be made to the disclosed methods and apparatus without departing from the invention. Therefore, it is the intent of the appended claims to cover all such variations and modification as come within the true spirit and scope of this invention.

What is claimed is:

1. A method of removing hydrocarbons or other contaminates from a body of water or fluids on or below the surface comprising the steps of:
(a) distributing recovery particles with an affinity for hydrocarbons (or affinity specifically designed for the contaminate of concern) into a body of water to remove the contaminate by adherence to the particle and subsequent removal of the particle and contaminate matrix;
(b) providing a soak time to allow any attraction mechanism to occur between the recovery particle and the contaminate
(c) providing a magnet to attract the contaminate/recovery particle matrix and equipment to remove the particle matrix from the base body of water

2. The method as recited in claim 1 wherein said method comprises the step of removing said hydrocarbons or other contaminates from a material matrix such as sand or earth

3. The method as recited in claim 1 wherein said method comprises the additional steps and equipment to clean the magnets of the contaminate/recovery particle matrix and return the magnets to service.

4. The method as recited in claim 1 wherein said method comprises the additional steps and equipment to clean the recovery particles of the contaminate and return the particles to service.

5. The method as recited in claim 1 wherein said method comprises the step of removing said hydrocarbons or other contaminates from an industrial tank

6. A method of removing hydrocarbons or other contaminates from a body of water or fluids on or below the surface comprising the steps of:
(a) distributing recovery particles with an affinity for hydrocarbons (or affinity specifically designed for the contaminate of concern) into a body of water to remove the contaminate by adherence to the particle and subsequent removal of the particle and contaminate matrix;
(b) providing a soak time to allow any attraction mechanism to occur between the recovery particle and the contaminate
(c) providing a vacuum, skimmer, conveyor, settling tank or other mechanical means of collecting and removing the contaminate/recovery particle matrix from the base body of water

8. The method as recited in claim 6 wherein said method comprises the step of using an ship or aircraft to distribute the recovery particle over a broad area in a short time at low cost

9. The method as recited in claim 6 wherein said method comprises the step of using injection nozzles set at specific depths in earth or in an industrial tank to deliver the recovery particles. The method may include the addition of delivery fluids, such as liquid Carbon Dioxide, Air or Propane to help move the recovery particle to the desired location

10. The method as recited in claim 6 wherein said method comprises the step of providing an anode/cathode pairing or other electro or electrochemical means of exciting and accelerating the recovery particle attraction mechanism

11. The method as recited in claim 6 wherein said method comprises the step of providing an anode/cathode pairing or other electro or electrochemical means of exciting and accelerating the separation of the contaminate/recovery particle matrix from the separation equipment, including the magnet

12. The method as recited in claim 6 wherein said method comprises the step of providing an anode/cathode pairing or other electro or electrochemical means of attracting and removing the contaminate/recovery particle matrix from a material matrix such as sand or earth

13. The method as recited in claim 6 wherein said method comprises the step of providing an anode/cathode pairing or other electro or electrochemical means of attracting and removing the contaminate/recovery particle matrix from an industrial tank

14. A method of removing hydrocarbons or other contaminates from a body of water or fluids on or below the surface comprising the steps of:
(a) distributing recovery particles with an affinity for hydrocarbons (or affinity specifically designed for the contaminate of concern) into a body of water to remove the contaminate by adherence to the particle and subsequent removal of the particle and contaminate matrix;
(b) providing a buoyancy mechanism to the recovery particle set to suspend the recovery particle at a certain depth amenable to the recovery of contaminates at that depth
(c) providing a soak time to allow any attraction mechanism to occur between the recovery particle and the contaminate
(d) providing a magnet to attract the contaminate/recovery particle matrix and equipment to remove the particle matrix from the base body of water
(e) providing separation and cleaning equipment to remove the recovered contaminate/recovery particle matrix from the recovery equipment and dispose of them into designated containers

15. The method as recited in claim 14 wherein said method comprises the step of removing said hydrocarbons or other contaminates from a material matrix such as sand or earth

16. The method as recited in claim 14 wherein said method comprises the additional steps and equipment to clean the recovery particles of the contaminate and return the particles to service.

17. The method as recited in claim 14 wherein said method comprises the step of removing said hydrocarbons or other contaminates from an industrial tank
